(19) United States
(12) Patent Application Publication
(10) Pub. No.: US 2013/0175930 A1
(43) Pub. Date: Jul. 11, 2013

(54) Illuminated Pet Bed Device

(71) Applicant: Cristina Cawman, Enterprise, AL (US)

(72) Inventor: Cristina Cawman, Enterprise, AL (US)

(21) Appl. No.: 13/721,150

(22) Filed: Dec. 20, 2012

Related U.S. Application Data
(60) Provisional application No. 61/583,675, filed on Jan. 6, 2012.

(51) Int. Cl. H05B 37/02

(52) U.S. Cl. CPC H05B 37/02
USPC 315/158; 315/362

(57) ABSTRACT

Disclosed is an illuminated pet bed having a pressure activated night light that allows a pet to locate their bed in low light and deactivate the light once the pet is positioned thereon for sleeping. The device includes a power source connection, a control interface, and a light source within the bed. At least one switch energizes or deactivates the light source based on input from the pet, owner, or the ambient environment. In a preferred embodiment, there is provided a first pressure switch, a second light sensor switch, a third timer switch, and manual override (“ON” and “OFF”) switches. The pressure switch is a normally closed switch that breaks continuity between the power and the light source when the pet is positioned on the bed, while the other switches are related to manual control or activation of the light during certain periods.

### CROSS REFERENCE TO RELATED APPLICATION

This application claims the benefit of U.S. Provisional Application No. 61/583,678 filed on Jan 6, 2012, entitled “Lighted Pet Bed.” The above identified patent application is herein incorporated by reference in its entirety to provide continuity of disclosure.

### BACKGROUND OF THE INVENTION

1. Field of the Invention

The present invention relates to pet beds and night light devices. More specifically, the present invention pertains to a pet bed with a pressure sensitive light source that provides a soft night light in twilight conditions prior to the pet positioning itself onto the bed.

Pet beds are devices that allow a domestic indoor pet to rest comfortably during the night. These devices included padded regions and various designs that afford comfort for the pet and separation from the floor surface. These devices employ different materials, shapes and features for the purposes of providing a comfortable resting place for a dog or cat. Generally these beds fit a single pet and require owners of multiple pets to have an individual bed to accommodate each pet. A common problem with these articles for some pets is locating the bed in low light conditions. Pets can get up during twilight periods and return to the bed freely, therefore locating the bed in the dark is necessary to prevent stumbling, tripping or having the pet be uncomfortable and sleep on an uncovered surface. This is particularly true in settings with multiple pets, where accurate locating of one's bed is necessary to prevent collisions with neighboring pets, waking them up and causing confrontations in the night.

Another associated problem with lighted furniture and lighted pet beds is the ability of the user to deactivate the light source once the pet has entered the bed. Generally pet owners will place wall socket night lights adjacent to the pet bed; however this provides not means by while to deactivate the light source for uninterrupted sleep or a fully darkened environment for the pet or owner to sleep. Having an illuminated area may keep the pet and the owner unnecessarily awake, or may require the owner to deactivate the light once the pet has located the bed. This eliminates the ability of the pet to leave the bed later in the night and easily return in the darkness.

The present invention pertains to lighted furniture as it relates to pet sleeping beds. The present invention fulfills a long felt need in the art of pet bed devices by providing an illuminated and pressure-activated bed that reacts to the presence of the pet on the bed and can be manually controlled by the pet owner. The pressure switch controls when the light source is energized, while a plurality of additional switches allow for manual control of the light for desired times or intervals. A timer switch allows a pet owner to activate the light during certain periods of the day (i.e. in twilight only), while a light sensor may be included to automatically account for the lighting conditions within the environment and energize the light based on its programmed logic. Once the pet enters the bed, the light is deactivated such that the room is sufficiently darkened to allow the pet to sleep with ease.

2. Description of the Prior Art

Devices have been disclosed in the prior art that relate to illuminated furniture device. These include devices that have been patented and published in patent application publications, and generally relate to seat cushions and other furniture articles that have imbedded illumination means for decoration or style purposes. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,559,667 to Holderman discloses a lighted seat cushion having a bottom, middle and top layer. The bottom layer is adapted to rest against a seat surface and provide a layer of padding. The middle layer includes one or more lights within the layer substrate connected to an electrical circuit. The circuit includes a power supply, wiring, and a switch to illuminate the lights within the cushion. The top layer of the pad includes a thickness and construction to allow the lights of the middle layer to shine therethrough. The switch controls the operation, color, intensity and patterns of light within the cushion. The Holderman device describes a chair cushion having novelty lights built into its construction. The present invention provides a pressure sensitive pet bed having night lighting therein. The construction and intent of the present invention diverges from that of the Holderman device.

Another such device is U.S. Published Patent Application Publication No. 2006/0087165 to Gharabegian, which discloses a seating structure that includes a frame, a seat, a translucent seat back, and an illumination source. The illumination source causes the seatback to glow in a similar fashion as the Holderman device, where the color can be updated to different colors for decorative purposes. A switch is provided for updating the color based on the user's requirements, updating the color shining through the seatback of the structure. Similar to the Holderman device, the Gharabegian device provides for a glowing article of furniture for decorative or novelty purposes. The present invention pertains to an illuminated pet bed that allows a pet to find the bed in low light and cease the operation of the light when the pet engages the bed prior to resting or sleeping.

Finally, U.S. Pat. No. 6,126,233 to Gaetano discloses a child safety seat that includes an integral illumination system that is remotely activated to cast light on a seated child while in a car to monitor the child in low light. A portable remote device allows a driver or passenger of a vehicle to energize the lights and control the intensity of the light generated. The lights are integrated into the structure of the safety seat and provide a soft or high intensity light as desired by the user controlling the remote. Similar to the aforementioned disclosures, the Gaetano device fails to provide a pressure sensitive light source and one that provides the location of a bed or cushion in low light. The Gaetano device relates to a child safety and monitoring light for use in a vehicle and in low light.

The present invention pertains to an illuminated pet bed having a pressure switch to control operation of the light sources and a plurality of user inputs for which the pet owner can control and operate the device independently of the pressure switch. The device offers a pet with a sleeping area with an imbedded night light that deactivates once the pet has entered the bed. It is submitted that the present invention substantially diverges in design elements from the prior art, and consequently it is clear that there is a need in the art for an improvement to existing illuminated pet bed devices. In this regard the instant invention substantially fulfills these needs.

### SUMMARY OF THE INVENTION

In view of the foregoing disadvantages inherent in the known types of pet bed devices now present in the prior art, the present invention provides a new illuminated pet bed device that can be utilized for providing convenience of a pet owner when placing a pet bed in low light environments and for providing pets with a readily locatable bed in twilight hours.

It is therefore an object of the present invention to provide a new and improved pet bed device that has all of the advantages of the prior art and none of the disadvantages.

It is another object of the present invention to provide a pet bed device that includes a padded region for which the pet to rest upon and a light source that provides a means of locating the bed in low light conditions.

Another object of the present invention is to provide a pet bed device that includes a pressure-activated switch that controls when the light source of the bed is energized, allowing the light source to be deactivated once the pet locates and rests on the bed.

Yet another object of the present invention is to provide a pet bed device that includes a pet owner interface for manual control of the bed light source, including manual override control and timer control of the light.

Another object of the present invention is to provide a pet bed device that includes a light sensor switch to control activation of the light only during twilight or low light hours to preserve energy and the longevity of the light source.

A final object of the present invention is to provide a pet bed device that is comfortable for the pet to sleep upon and one that includes imbedded electronics that do not detract from the comfort or design of the bed.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a preferred embodiment of the pet bed electrical switch logic.

FIG. 2 shows a view of an embodiment of the pet bed device and the pet owner control interface.

FIG. 3 shows the pet bed device in use by a dog.

FIG. 4 shows an embodiment of the pet owner interface positioned along the device power cord.

### DETAILED DESCRIPTION OF THE INVENTION

Reference is made herein to the attached drawings. Like reference numerals are used throughout the drawings to depict like or similar elements of the pet bed device. For the purposes of presenting a brief and clear description of the present invention, the preferred embodiment will be discussed as used for providing an illuminated pet bed that is controlled by the owner and by sensing the pressure of the pet on the bed for deactivating the light during periods of use. The figures are intended for representative purposes only and should not be considered to be limiting in any respect.

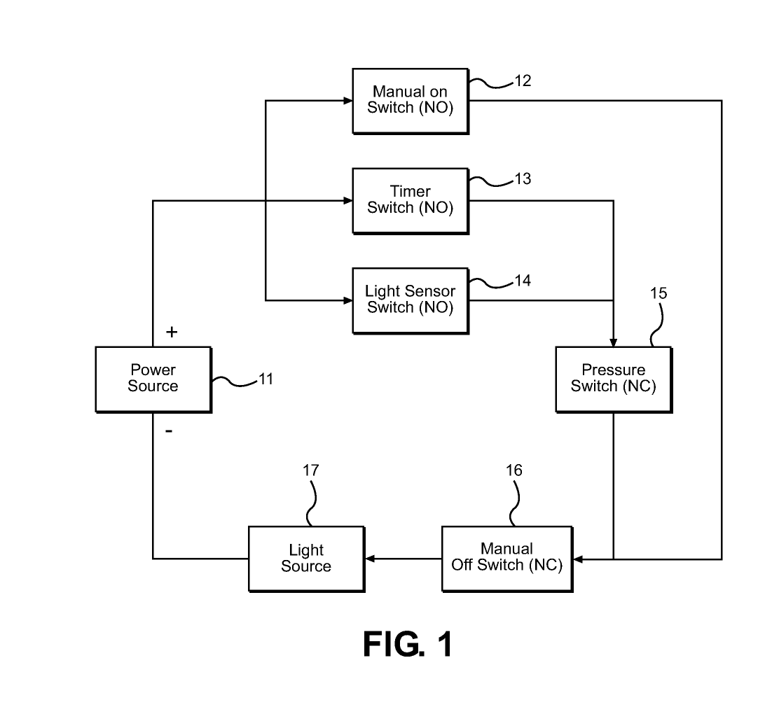

Referring now to FIG. 1, there is shown a diagram of the electrical circuit logic that controls when the pet bed of the present invention becomes energized and when the light sources are deactivated. The electrical circuit is imbedded within the interior padding or structure of the pet bed and connects a power source 11, such as a battery pack or wall outlet power, to at least one light source 17 within the bed. The light source 17 provides a night light for illuminating the bed in low light conditions, allowing the pet to readily locate the bed at night. The circuit comprises at least one control switch for activating and deactivating the light source 17. In a preferred embodiment and as shown in FIG. 1, a plurality of different switches are provided to control the flow of current from the power source 11 to the light source 17. In this embodiment, a normally closed pressure switch 15 is positioned between the power source 11 and the light source 17 to control allow the light 17 to be energized normally and then deactivated once pressure from a resting pet opens the switch 15 and ceases power to the light source 17. This switch 15 may be used by itself in the simplest embodiment, or in combination with other switches as shown in the preferred layout.

In the preferred layout, a means of controlling the light source 17 operation without the presence of a pet is provided, including a light sensor switch 14 and a timer switch 13. The light sensor switch 14 is a normally open switch that closes when light drops below a given threshold. This allows the light source 17 to only operate in low light and deactivate during daylight periods. Once twilight hours commence, the light sensor switch 14 closes and relies on the pressure switch 15 to control the light source 17. Similarly, a timer switch 13 may be provided to allow a pet owner to program the device to operate during certain periods of the day. This switch is also a normally open switch that closes when a given time period has lapsed or a programmed time of day is crossed. Different layouts are contemplated where the timer switch 13 may be positioned along an independent path from the pressure switch 15 to override the pressure switch 15. Further switches include a manual “ON” switch 12 that allows the light 17 to energize on demand by the pet owner. A manual “OFF” switch 16 allows the entire operation of the light 17 to be deactivated, independently of the sensors and preceding switch positions. It is noted that is not desired to limit the present invention to the layout shown in FIG. 1, but rather to disclose a working embodiment that includes a plurality of user controls over the operation of the light source. In another embodiment, the disclosed switches may be replaced with a microprocessor having programmed logic to control the path of current from the power source 11 to the light source 17. This embodiment provides greater flexibility with regard to user control, but may be added cost for the microprocessor.

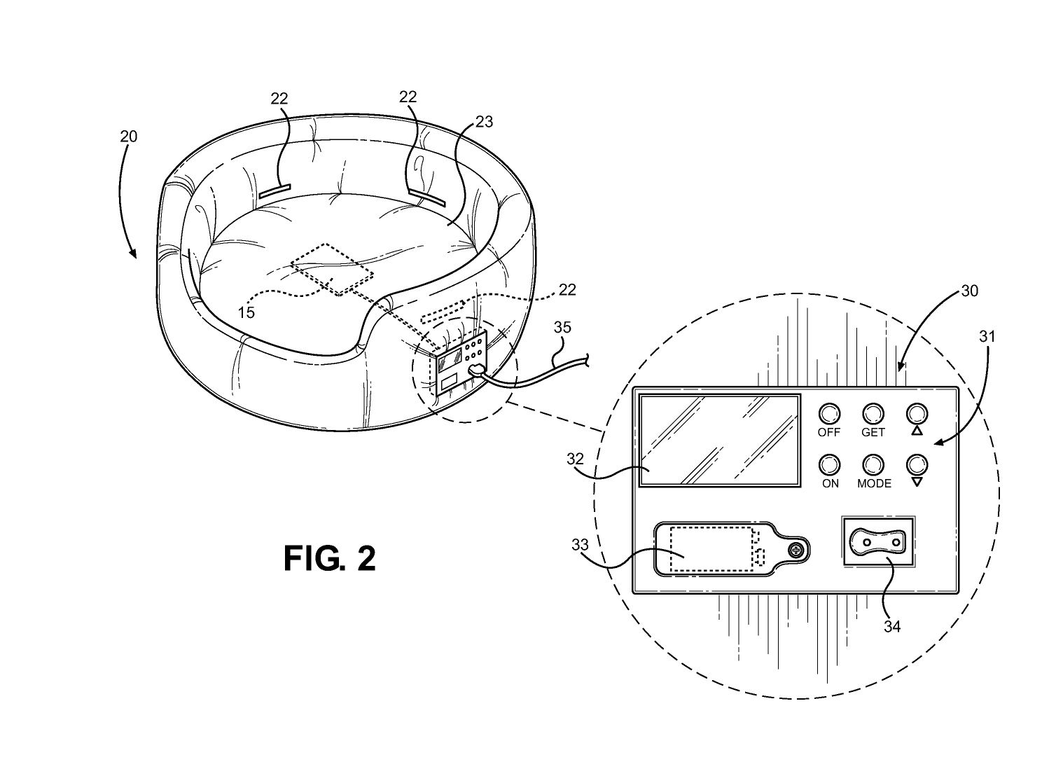

Referring now to FIG. 2, there is shown an overhead perspective view of the lighted pet bed 20 of the present invention and a close-up view of the pet owner control interface 30. The design of the pet bed 20 may take any form desirable for the given pet and the tastes of the pet owner, which includes a padded sleeping area 23 housing an imbedded pressure switch 15 therein. Once the pet rests on the sleeping area 23, the switch 15 is opened to deactivate the light sources 22 within the bed and make the area dark for sleeping. Once the pet leaves the sleeping area 23, the switch 15 closes and activates the lights 22 once again to allow the pet to easily find the bed in twilight hours. Along the side of the bed 20 a user interface 30 is provided for programming and controlling the lights 22. The interface 30 includes a display screen, selection buttons 31 of operating the different modes/options of the lights 22, and finally includes an area for powering the device. Power may be provided by an internal battery 33 or alternatively by an outlet cord 35 plugged into the interface 34. Battery power allows the bed to be positioned away from a power source and allows the owner to travel with the bed as desired; however the NC power from the wall provides a constant source of energy that does not require user vigilance to monitor for battery life. A battery life indicator may be provided on the display or a means of notifying the owner, or alternatively both outlet power 34 and battery power 33 may be both included, whereby the batter 33 is rechargeable and offers the owner the flexibility to choose the mode of power.

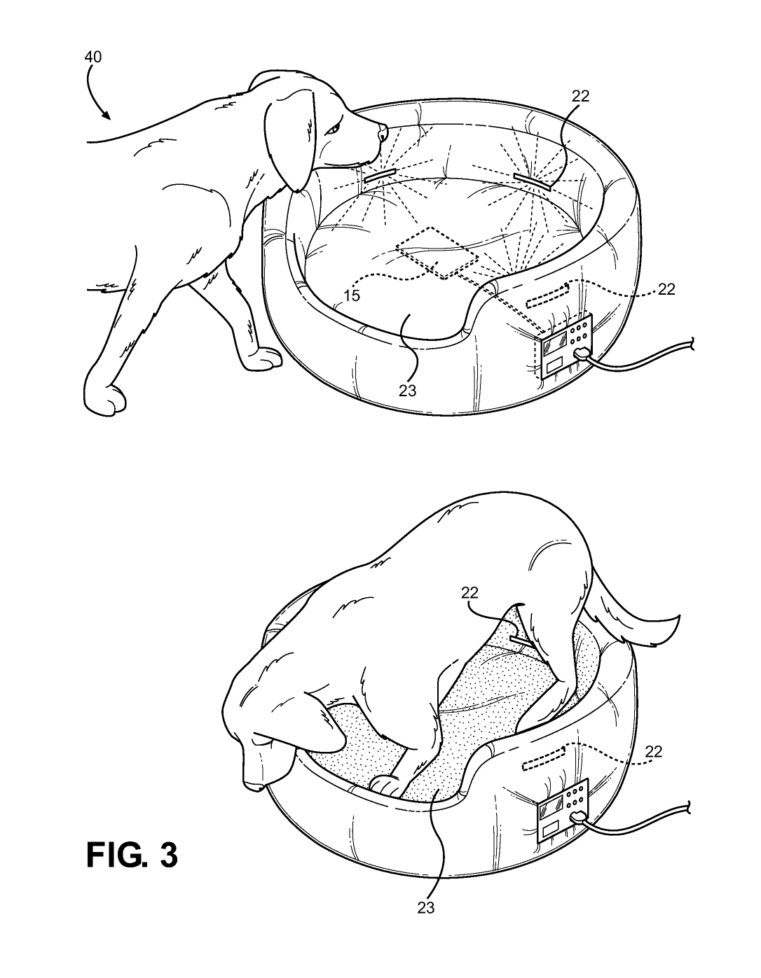

Referring now to FIG. 3, there is shown a view of the present invention in a working state, allowing a dog 40 to enter the bed sleeping area 23, whereafter the lights 22 are de-energized to prevent the lights from keeping the dog 40 awake during the night. The pressure switch 15 is preferably placed centrally within the sleeping area or padded base area 23 of the bed, whereby the weight of the pet 40 affects a state change in the switch to deactivate the lights 22. In an alternate embodiment, several pressure switches may be placed about the base pad area 23 in a lattice to ensure that the pet 40 is presence is realized. This is particularly important for larger beds and smaller pets, where a single switch 15 may not be affected by the weight of the pet 40 if the pet is not directly above the switch 15.

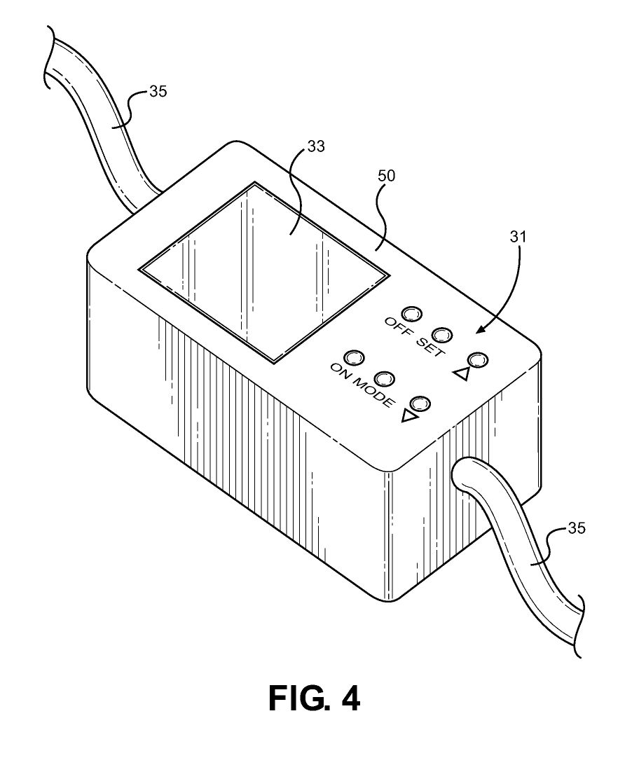

Referring finally to FIG. 4, there is shown a view of an alternate placement for the owner control interface 50, wherein the interface is placed in-line with a power cord 35. In this embodiment, the interface is not affixed to the pet bed and therefore does not interfere with its primary objective of providing a comfortable and lighted bedding area for the pet. Since the interface may be an enlarged electronic module, its placement along the power cord 35 allows it to be away from the bed and independently operated therefrom. Signals are sent through the cord 35 to and from the bed once connected, affecting the same control over the light sources are provided in the interface embodiment affixed to the bed. A display screen 33 and user inputs 31 are provided on the interface 50 to allow the pet owner to control operation, timing and setting of the bed.

The present invention provides pets with a convenient way to guide themselves toward their bed in the dark. The device is a padded pet bed commonly known in the art that illuminates in low light conditions and based on user control. In a preferred embodiment, the lights are energized when the light sensor switch indicates a period of low light or upon a timer threshold, whereafter the pet placing itself on the bed deactivates the lights for a darkened sleeping environment. The user can manually override the light and pressure sensors as desired, while power is derived from battery and/or A/C outlet power. In operation, the device allows pets to navigate their way to the bed and to see if another pet has already claimed the bed for the night. This product prevents animals from sleeping on furniture or on the cold floor, as they can quickly locate and enter their bed. Several embodiments are disclosed for the purposes of controlling the light sources. The cushion material and the design of the bed itself can take any desired form; these include thinner pillow beds that fit well within pet crates and are useful for transporting with the pet, or a larger, static bed structures that are not adapted to be transported. It is not desired to limit the present invention to a given bed design or electrical layout, but rather to it is desired to disclose an illuminating pet bed that provides a pet with a means to locate the bed and provide an owner with a portable or static pet bed device having an imbedded night light.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An illuminated pet bed device, comprising:
a base area having a thickness adapted to support a resting pet thereon;
at least one light source;
a power source;
a pressure switch connected between said power source and said light source and positioned within said base area;
said pressure switch deactivating said light source when pressure is applied to said base area.

2. The device of claim 1, further comprising a light sensor switch that energizes said light source in dim light.

3. The device of claim 1, further comprising a timer switch that energizes said light source based on a programmed clock setting.

4. The device of claim 1, further comprising a manual “ON” switch that energizes said light source independent of said pressure switch.

5. The device of claim 1, further comprising a manual “OFF” switch that deactivates said light source independent of said pressure switch.

6. The device of claim 1, further comprising a user interface for controlling said light source operation.

7. The device of claim 6, wherein said user interface is attached to said pet bed.

8. The device of claim 6, wherein said user interface is along a cord attached to said pet bed.

9. The device of claim 1, wherein said power source further comprises a battery power source.

10. The device of claim 1, wherein said power source further comprises wall outlet power.

11. The device of claim 1, further comprising a microprocessor with programmed logic to accept user input through a user interface and control said light source.
